(19) United States
(12) Patent Application Publication
(10) Pub. No.: US 2006/0260283 A1
(43) Pub. Date: Nov. 23, 2006

(54) MULTI-FUNCTION PERIPHERAL DEVICE WITH AIR CLEANING FUNCTION

(76) Inventor: Chih-Hsien Wei, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,603

(22) Filed: Oct. 25, 2005

(30) Foreign Application Priority Data
May 18, 2005 (CN) 200510072947.4

(51) Int. Cl. B01D 50/00

(52) U.S. Cl. 55/385.6

(57) ABSTRACT

A multi-function peripheral device includes an electronic business module for performing a predetermined operation, and an air cleaning module, integrated in the electronic business module, for filtering out waste air generated by the electronic business module when performing the predetermined operation.

### BACKGROUND OF THE INVENTION

1. Field of the Invention

This invention provides a multi-function peripheral device, which particularly includes an air cleaning module.

2. Description of the Prior Art

Developments in modern technology have resulted in many kinds of electronic products being available on the market. Life has become considerably more convenient by the appearance of electronic peripheral devices.

People are already familiar with the functions and operations of common electronic peripheral devices, such as printers, scanners, and multi-function peripheral devices etc. All of the aforesaid peripheral devices can provide a copy function by using a light source to scan a specified document, or transfer a specified document into an e-file for a customer's subsequent use. Unfortunately, however, these electronic peripheral devices may produce waste gas harmful to the body.

People using such electronic devices over a long period of time often do not realize they have suffered lung diseases as a result of being exposed to the waste gas. Evidently, the problem of waste gas is one of the most pressing problems associated with electronic devices.

### SUMMARY OF THE INVENTION

Hence, the main objective of the present invention is to provide an electronic device that includes an air cleaning module, so as to resolve the prior art problems.

A multi-function peripheral device having an air cleaning function, includes an electronic business module for performing a predetermined operation, and an air cleaning module integrated in the electronic business module, for filtering waste gas arising from the predetermined operation performed by said electronic business module.

This invention, through the inclusion of an air cleaning module, can filter waste gas produced by the electronic device to prevent a user from inhaling excessive waste gas.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is the diagram of a scanner of this invention.

FIG. 2 is a diagram of the main machine of the scanner shown in FIG. 1.

FIG. 3 is a structural diagram of the air cleaning device shown in FIG. 1.

FIG. 4 is another embodiment of the scanner of the present invention.

### DETAILED DESCRIPTION

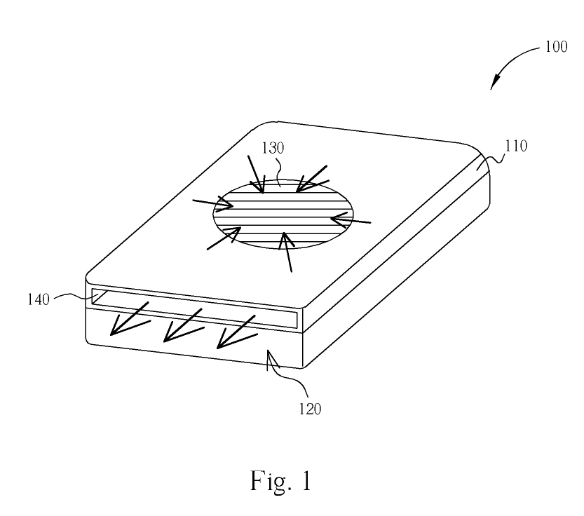

Please refer to FIG. 1. FIG. 1 is the diagram of a scanner 100 of this invention. As shown in FIG. 1, the scanner 100 contains an air cleaning device 110 and a main machine 120 of the scanner 100. The air cleaning device 110 is located in the inner part of the scanner's upper housing, and the main machine 120 of the scanner is located in the inner part of the lower housing. As the main machine 120 of the scanner generates exhaust gas when operating, the air cleaning device 110 filters the exhaust gas. In FIG. 1, the air cleaning device 110 comprises an inlet hole 130 and a vent hole 140, allowing air to enter the air cleaning device 110 through the inlet hole 130, and filtered air to be emitted through the vent hole 140. The detailed structure and function of the scanner 100 is described as follows:

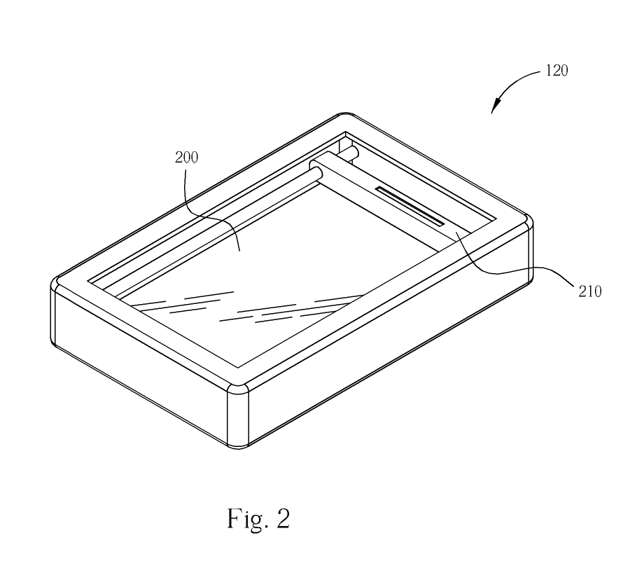

Please refer to FIG. 2. FIG. 2 is a diagram of the main machine 120 of the scanner 100 as shown in FIG. 1. The main machine 120 comprises transparent glass 200, which is used to load a document, and a light source module 210, which is a movable device for exposing the document so as to achieve the general function of the main machine 120 of the scanner. The main machine 120 of the scanner contains some circuits used to determine exposure of the document. Since the function and structure of such circuits are well known in the industry, this point will not be detailed in depth.

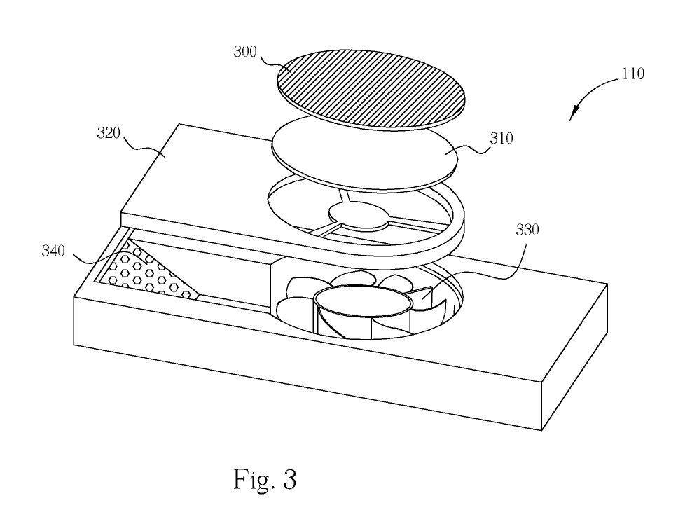

Please refer to FIG. 3. FIG. 3 is a structural diagram of the air cleaning device 110 as shown in FIG. 1. As shown in FIG. 3, the air cleaning device 110 comprises a filter cover 300 and a filter 310, which are used to filter micro-particles in the air, and further includes a fan cover 320 and a motor fan module 330. The filter cover 300 is located upon the filter 310, and is used to filter micro-particles in the air so that the micro-particles will stay in the filter 310 without entering the air cleaning device 110. The fan cover 320 is located upon the motor fan module 330. Please note, as shown in FIG. 3, there is a space below the motor fan module 330 to allow the waste air to be filtered to flow therein. The motor fan module 330 operates through its fan to introduce the waste air outside the air cleaning device 110 into the air cleaning device 110. In addition, in this embodiment, the air cleaning device 110 is preferably a photocatalyst air cleaning device, and the air cleaning device 110 further comprises a photocatalyst board 340 for triggering a photocatalyst reaction to clear up toxic ingredients of the air.

Generally speaking, in order to trigger the photocatalyst reaction, light of certain energy needs to first illuminate the photocatalyst such that electrons on the surface of the photocatalyst can absorb enough energy to depart from the photocatalyst. Therefore, the positions, where the electrons moves away, have electronic holes because of the removed electrons. Furthermore, these electronic holes will oxidize OH— ionized from nearby H₂O (namely, taking an electron from the hydroxy radical), causing OH— to become a hydroxy free radical with high activity. Once a hydroxy free radical encounters an organic substance, it will retake an electron, and thus the organic molecule will disintegrate due to bond breaking. Since most common pollutant resources are organic substances, the photocatalyst reaction can achieve the goals of cleaning air and disinfection. In other words, the goal of filtering waste gas can be achieved. From the above-mentioned photocatalyst reaction theory, the scanner 100 must have certain elements in order to trigger the photocatalyst reaction.

In general, the photocatalyst is made by titania. As mentioned above, an external light source should provide enough energy to the electrons of titania such that the electrons of titania can be triggered to move from the valence band to the conduction band. In other words, the waveform of the external light source substantially corresponds to 380 nm, which corresponds to the frequency band of the ultraviolet. Therefore, in this embodiment, ultraviolet is the most appropriate light source to trigger the photocatalyst reaction.

Based on the aforementioned reasons, the photocatalyst board 340 of the scanner 100 comprises a titania coat for the photocatalyst reaction. Therefore, when the titania coat receives ultraviolet lights, the photocatalyst reaction can be triggered. In addition, the light source module 210 of the main machine of the scanner not only comprises the original light source, but also comprises the ultraviolet light source. Obviously, the ultraviolet light source is utilized to generate ultraviolet lights such that the photocatalyst reaction can be triggered. Furthermore, a light route is needed to ensure that the ultraviolet light outputted by the ultraviolet light module can illuminate the photocatalyst board 340.

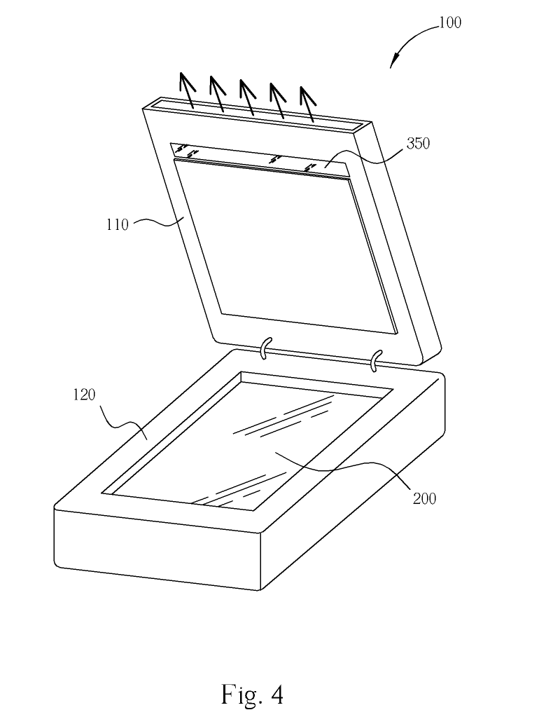

Please refer to FIG. 4, which is another diagram of of the scanner 100 of the present invention. As shown in FIG. 3, there is a transparent area 350, which corresponds to the position of the photocatalyst board 340, located on the contact interface of the air cleaning device 110 and main machine 120. Please note, the transparent area 350 is used to provide the aforementioned light route. Therefore, ultraviolet lights outputted by the ultraviolet light source of the main machine 120 can run through the transparent glass 200 and the transparent area 350 to reach the photocatalyst board 340. This makes the photocatalyst reaction possible.

Please note that the above-mentioned photocatalyst air cleaning device is only utilized as a preferred embodiment, not a limitation of the present invention. That is, other air cleaning devices may also be used. For example, an active carbon air cleaning device can be utilized. This also obeys the spirit of the present invention. In addition, in the embodiment of the photocatalyst air cleaning device, the above-mentioned structure of the photocatalyst air cleaning device 110 is also utilized as a preferred embodiment. For example, the photocatalyst board 340 within the air cleaning device 110 could utilize a photocatalyst honeycomb board to provide a larger reaction surface for the photocatalyst reaction so as to filter air more effectively. However, photocatalyst boards with other shapes could also be chosen according to different demands. This change also obeys the spirit of the present invention.

Please note that the photocatalyst reaction is not limited to use ultraviolet rays and titania. A specific photocatalyst, which can be triggered by visible lights, has been developed. Therefore, the present invention scanner can comprises the specific photocatalyst coat on the photocatalyst board 340 instead of titania. Therefore, the above-mentioned ultraviolet light source is no longer needed since the original light source can provide visible lights. This change also obeys the spirit of the present invention.

Moreover, in this embodiment, the air cleaning device 110 is established in the inner part of the upper housing of the scanner 100. However, the aforementioned structure is also regarded as an embodiment of this invention. In the actual implementation, as long as the air cleaning device 110 is integrated with the scanner 100, waste gas generated from scanner 100 can be filtered out. This change also obeys the spirit of the present invention.

In addition, the scanner is only utilized as an embodiment, not a limitation of the present invention. That is, in the actual implementation, other devices can be utilized via the concept of the present invention. For example, multi-function peripheral devices and electronic peripheral devices, such as Photostat, etc, can comprise the air cleaning module as long as the multi-function peripheral devices and electronic peripheral devices can share the same light module with the air cleaning module. In a preferred embodiment, the present invention is implemented inside an electronic device having a scan or copy function (exposure function) such that the light module of the electronic device can be shared. Surely, if the original electronic device comprises no light module, the present invention should add not only the air cleaning module, but also another light module for the photocatalyst reaction. This change also obeys the spirit of this invention.

In contrast to the prior art, the electronic device of the present invention comprises an air cleaning module, and thus can filter outwaste gas produced from the electronic device so as to prevent a user from inhaling excessive waste gas that damage the user's health.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-function peripheral device with an air cleaning function, the multi-function peripheral device comprising:
an electronic business module for performing a predetermined operation; and
an air cleaning module, integrated in the electronic business module, for filtering out waste air generated by the electronic business module when performing the predetermined operation.

2. The multi-function peripheral device of claim 1, wherein the air cleaning module is a photocatalyst air cleaning module.

3. The multi-function peripheral device of claim 2, wherein the electronic business module comprises:
a light source module for providing a light source needed for the photocatalyst air cleaning module.

4. The multi-function peripheral device of claim 3, wherein the light source module is utilized for exposing a document in a mobile way.

5. The multi-function peripheral device of claim 4, wherein the electronic business module is a scanner.

6. The multi-function peripheral device of claim 5, wherein the scanner comprises an upper housing and a lower housing and the photocatalyst air cleaning module is integrated in the upper housing of the scanner.

7. The multi-function peripheral device of claim 4, wherein the electronic business module is a photostat.

8. The multi-function peripheral device of claim 7, wherein the photostat comprises an upper housing and a lower housing and the photocatalyst air cleaning module is integrated in the upper housing of the photostat.

9. The multi-function peripheral device of claim 4, wherein the electronic business module is a multi-function peripheral machine, and the multi-function peripheral machine comprises functions of at least scanning and printing.

10. The multi-function peripheral device of claim 9, wherein the multi-function peripheral machine comprises an upper housing and a lower housing and the photocatalyst air cleaning module is integrated in the upper housing of the multi-function peripheral machine.

11. The multi-function peripheral device of claim 4, wherein the light source module comprises:
a visible light source for outputting visible light to the document; and
an ultraviolet light source for outputting ultraviolet light to the photocatalyst air cleaning module.
